(19) United States
(12) Patent Application Publication
(10) Pub. No.: US 2016/0299449 A1
(43) Pub. Date: Oct. 13, 2016

(54) ELECTROSTATIC IMAGE DEVELOPING TONER

(71) Applicant: Mitsubishi Chemical Corporation, Chiyoda-ku (JP)

(72) Inventor: Tadashi MIZUNO, Niigata (JP)

(73) Assignee: Mitsubishi Chemical Corporation, Chiyoda-ku (JP)

(21) Appl. No.: 15/190,372

(22) Filed: Jun. 23, 2016

Related U.S. Application Data
(63) Continuation of application No. PCT/JP2014/083998, filed on Dec. 22, 2014.

(30) Foreign Application Priority Data
Dec. 25, 2013 (JP) 2013-267645

(51) Int. Cl. G03G 9/097

(52) U.S. Cl. CPC G03G 9/09725

(57) ABSTRACT

An object of the present invention is to properly control a fluidity and chargeability of a toner and to achieve both of white-spot prevention and good toner consumption. The invention relates to an electrostatic image developing toner comprising: toner base particles that contain at least a binding resin, a coloring agent and a wax; and an external additive, wherein the external additive contains silica particles (a), silica particles (b), and particles (c), which satisfy particular requirements.

### TECHNICAL FIELD

The present invention relates to an electrostatic image developing toner to be used in electrophotography, electrostatic photography, and the like.

### BACKGROUND ART

Electrophotography generally includes steps of forming an electrostatic latent image on a photoconductive photoreceptor by any of various methods, subsequently making the latent image visible using an electrostatic image developing toner (hereinafter sometimes abbreviated as a “toner”), thereafter transferring the visible toner image to a receiving material, e.g., paper, and fixing the toner image by heating, pressing, or the like. Various methods are known as these steps, and methods suitable for the respective image forming processes have been adopted.

As one of typical methods for producing toners, there is a pulverization method wherein various materials such as a binder resin, a coloring agent, and a charge control agent are melted and mixed, and pulverized and classified to obtain fine particles, and it has been widely employed, since a tonner having a good quality is obtained in a relatively simple and convenient manner, regardless of various kinds of developing methods such as color and monochrome. Moreover, in order to respond recent requests to the electrophotography for further increase in speed and image quality, polymerized toners have been intensively studied and developed. Since control of particle diameter is easier in the polymerized tonners than in pulverized tonners, it is possible to obtain toner base particles having a small particle diameter suitable for the increase in image quality.

Furthermore, since it is also possible to capsulate a toner by particle structure control, there is a merit that a toner having excellent heat resistance and low-temperature fixability is obtained.

Various investigations have been made for the purpose of achieving control of chargeability and fluidity for obtaining a stable high image quality in addition to the decrease in particle diameter of the toner as mentioned before.

For example, there are known a technology of externally adding small-particle-diameter silica particles having an average primary particle diameter of 7 to 35 nm in order to obtain suitable chargeability and transferability of a toner and a technology of imparting charge stability by a technology of externally adding large-particle-diameter silica particles having an average primary particle diameter of 50 to 200 nm in order to secure durability.

### PRIOR ART DOCUMENTS

### Patent Documents

Patent Document 1: JP-A-2001-109185

Patent Document 2: JP-A-2012-27142

Patent Document 3: JP-A-2001-66820

Patent Document 4: JP-A-2002-108001

Patent Document 5: JP-A-2000-247626

Patent Document 6: JP-A-60-255602

### SUMMARY OF THE INVENTION

### Problems that the Invention is to Solve

In Patent Document 1, it is reported to use small-particle-diameter silica particles having a specific surface area of 60 m²/g or more produced by a dry method for fluidity improvement as a toner. As a result of investigation of the present inventors, it is found that, in the case where the small-particle-diameter silica particles having a specific surface area of 60 m²/g or more are used without using large-particle-diameter silica particles in combination, charge quantity distribution of the toner gets worse and white spots are generated. This is considered to be attributable to transfer failure caused by aggregating excessively charged toners each other to increase contact points of the toners with a transfer member.

For solving the above problem, it is known to use large-particle-diameter silica particles together with small-particle-diameter silica particles. Specifically, there are cases where silica particles obtained by a dry method as reported by Patent Document 2 or silica particles obtained by a wet method as reported by Patent Documents 3 and 4 are used as the large-particle-diameter silica particles.

As a result of investigation of the present inventors, since the large-particle-diameter silica particles obtained by a dry method are likely to aggregate, when the particles are externally added to a toner, there is a case where toner consumption gets worse due to a decrease in fluidity and charge stability at the time when frictional charging is repeated. Moreover, since the large-particle-diameter silica particles obtained by a wet method have a low aggregation ability and a high circularity, there is a case where contact points between toner base particle surfaces and the silica particles are a few, the silica particles are detached from the toner base particle surfaces, and the deterioration of toner consumption is invited due to the decrease in charge stability. In other words, in the toner using the conventional large-particle-diameter silica particles obtained by a dry method or a wet method and the small-particle-diameter silica particles in combination as an external additive, an excessive amount of the toner may be supplied by the reason that the charge quantity cannot respond to toner supply control at the machine side.

On the other hand, in the case where small-particle-diameter silica particles are used in combination with large-particle-diameter silica particles, the chargeability becomes unstable when the specific surface area of the small-particle-diameter silica particles is 140 m²/g or more or 50 m²/g or less, so that the toner consumption may get worse.

As mentioned above, there has not yet been provided a toner which appropriately controls the fluidity and chargeability of the toner and achieves both of white spot prevention and good toner consumption.

### Means for Solving the Problems

The present inventors have extensively investigated for solving the problems and have found that the problems can be solved by a toner containing both of large-particle-diameter silica particles obtained by a fusion method and silica particles having a particular specific surface area as an external agent to be adhered or fixed to toner base particle surfaces. In the present invention, the fusion method refers to a production method described in, for example, JP-A-2000-247626 or JP-A-60-255602 and is a method different from the dry method shown in JP-A-2012-27142 and the wet method reported in JP-A-2001-66820 or JP-A-2002-108001.

Specifically, in the fusion method, using metal silicon as a raw material, silicon is vaporized under a high-temperature environment and subjected to an oxidation reaction to form silica particles. Contrarily, in the dry method, a silicon chloride is combusted in a hydrogen flame and silica particles are formed by a hydrolysis reaction. On the other hand, in the wet method, silica particles are formed by a gel method or a precipitation method in which silica particles are formed by a neutralization reaction of a sodium silicate solution with sulfuric acid, a sol-gel method of forming the silica particles by hydrolyzing an alkoxide of silicon, such as tetramethoxysilane or tetraethoxysilane, in an acidic or alkaline hydrous organic solvent, or the other method.

The gist of the present invention is as follows.

1. An electrostatic image developing toner comprising: toner base particles that contain at least a binder resin, a coloring agent, and a wax; and an external additive, wherein the external additive satisfies the following (A) to (C):

(A) the external additive contains silica particles (a) obtained by a fusion method,

(B) the external additive contains silica particles (b) different from the silica particles (a) and specific surface area of the silica particles (b) is 50 m²/g or more and 140 m²/g or less, and

(C) the external additive contains particles (c) different from the silica particles (a) and the silica particles (b) and the particles (c) are charged to have a reverse polarity to that of the silica particles (b) and have specific surface area of 5 m²/g or more and 300 m²/g or less.

2. The electrostatic image developing toner according to the 1. above, wherein the particles (c) are silica particles treated with an aminosilane coupling agent.

### Advantage of the Invention

The toner of the present invention contains silica particles (a) obtained by a fusion method, silica particles (b) having a particular specific surface area, and particles (c) having chargeability different in polarity from the silica particles (b) as an external additive and thereby has advantages of no white spot generation, good toner consumption, and excellent chargeability.

### Modes for Carrying Out the Invention

The present invention is described below in detail. It should be noted that the invention is not limited by the following embodiment, and may be modified in any ways within the scope of the gist of the invention. Moreover, “weight” and “mass”, “part(s) by weight” and “part(s) by mass”, and “% by weight” and “% by mass” have the same meanings, respectively.

### <Constitution of Toner of the Invention>

The toner of the invention is a toner comprising toner base particles that contain at least a binder resin, a coloring agent, and a wax and comprising an external additive, wherein the external additive satisfies the following (A) to (C):

(A) the external additive contains silica particles (a) obtained by a fusion method,

(B) the external additive contains silica particles (b) different from the silica particles (a) and specific surface area of the silica particles (b) is 50 m²/g or more and 140 m²/g or less, and

(C) the external additive contains particles (c) different form the silica particles (a) and the silica particles (b) and the particles (c) are charged to have a reverse polarity to that of the silica particles (b) and have specific surface area of 5 m²/g or more and 300 m²/g or less.

### <Regarding Requirement (A) of the Invention>

The external additive contains the silica particles (a) obtained by a fusion method. The fusion method refers to the production method described in, for example, paragraphs [0007] to [0021] of JP-A-2000-247626 and columns of [Constitution of the Invention] and [Action of the Invention] ofJP-A-60-255602. As silica particles obtained by the fusion method, there may be specifically mentioned UFP30SHH, UFP40SHH, UFP50SHH, UFP50SHP, UFP40SHP, UFP30SHP, UFP25HH, UFP20HH (all manufactured by Denka Company Limited), and the like.

The average primary particle diameter of the silica particles (a) obtained by the fusion method is not particularly limited so long as the advantage of the invention is not remarkably impaired but a lower limit thereof is usually 40 nm or more, preferably 50 nm or more, and particularly preferably 60 nm or more. On the other hand, an upper limit thereof is usually 135 nm or less, preferably 125 nm or less, and particularly preferably 115 nm or less. When the average primary particle diameter of the silica particles (a) is too small, embedding thereof in the toner base particles becomes remarkable and fluidity gets worse in the latter half of durable printing, so that blurring and the like may occur. On the other hand, when the diameter is too large, owing to small effect of imparting fluidity, solid-following-up gets worse or the particles are less likely to adhere to the toner base particles, so that member contamination owing to detachment may occur. The average primary particle diameter of the silica particles (a) obtained by the fusion method is measured by the method to be described in Examples.

The addition amount of the silica particles (a) obtained by the fusion method relative to 100 parts by mass of the toner base particles is not particularly limited so long as the advantage of the invention is not remarkably impaired but a lower limit thereof is usually 0.01 parts by mass or more, preferably 0.05 parts by mass or more, and particularly preferably 0.1 parts by mass or more. On the other hand, an upper limit thereof is usually 3.0 parts by mass or less, preferably 2.5 parts by mass or less, and particularly preferably 2.0 parts by mass or less. When the addition amount of the silica particles (a) is too small, an effect of suppressing excessive charging is not sufficiently obtained and white spots and fogging may be generated. On the other hand, when the amount is too large, the member contamination owing to detachment from the toner base particles may occur.

### <Regarding Requirement (B) of the Invention>

The external additive to be used in the invention contains silica particles (b) that are different from the silica particles (a) obtained by the fusion method. The silica particles (b) are used in an adhered or fixed state on the toner surface as an external additive of a toner. In the invention, it is necessary that the specific surface area of the silica particles (b) is 50 m²/g or more and 140 m²/g or less. Also, a lower limit of the specific surface area of the silica particles (b) is preferably 55 m²/g or more and particularly preferably 60 m²/g or more. On the other hand, an upper limit thereof is preferably 130 m²/g or less, more preferably 120 m²/g or less, further preferably 100m²/g or less and particularly preferably 90 m²/g or less. When the specific surface area of the silica particles is too small, a ratio of toners having a low charge quantity increases and the charge quantity distribution becomes broad, so that the toner consumption may get worse or the silica particles are less likely to adhere to the toner base particles and thus the member contamination owing to detachment may occur. On the other hand, when the area is too large, a ratio of toners having a high charge quantity increases and the charge quantity distribution becomes broad, so that the toner consumption may get worse and fogging may occur or, owing to aggregation of the silica particles each other, a sufficient fluidity is not obtained at the time of addition to a toner and thus solid-following-up failure or cleaning failure may be invited. The specific surface area of the silica particles is measured by the method to be described in Examples.

Specific examples of the silica particles (b) satisfying the above specific surface area include NX90G and NX9OS (both manufactured by Nippon Aerosil Co., Ltd.) surface-treated with hexamethyldisilazane, and the like.

The addition amount of the silica particles (b) relative to 100 parts by mass of the toner base particles is not particularly limited so long as the advantage of the invention is not remarkably impaired but a lower limit thereof is usually 0.1 parts by mass or more, preferably 0.2 parts by mass or more, and more preferably 0.3 parts by mass or more. On the other hand, an upper limit thereof is usually 1.0 parts by mass or less, preferably 0.75 parts by mass or less, and more preferably 0.5 parts by mass or less. When the addition amount of the silica particles (b) is too small, a sufficient fluidity is not obtained and cleaning failure may occur. On the other hand, when the amount is too large, the detachment from the toner base particles becomes remarkable and thus the member contamination may occur or the toner charge quantity distribution becomes broad, so that fogging may be generated.

A method for producing the silica particles (b) is not particularly limited and the particles can be prepared by known methods but are preferably produced by a dry method. The dry method herein refers to a general production method by a reaction in a vapor phase, such as a method of flame hydrolysis of a silicon compound, a method of oxidation by a method of combustion in a flame, or a method of combined use of these reactions.

### <Regarding Requirement (C) of the Invention>

The toner of the invention further contains particles (c) different from the aforementioned silica particles (a) and silica particles (b), as an external additive. The particles (c) are particles to be charged to have a reverse polarity to that of the silica particles (b). By adhering and detaching the particles (c) to the toner base particles, the charging of the toner becomes uniform and is stabilized even under a high-temperature and high-humidity environment. The charging polarity and the charge quantity are measured by the methods to be described in Examples. Furthermore, in the invention, the specific surface area of the particles (c) is 5 m²/g or more and 300 m²/g or less. The specific surface area of the particles (c) is preferably 100 m²/g or more and preferably 200 m²/g or less.

The type of the particles (c) is not particularly limited but, in the case where the silica particles (b) are negatively chargeable, as positively chargeable particles, silica particles, melamine-based resin particles, positively chargeable acrylic resin particles, and the like can be used. In the case where the silica particles (b) are negatively chargeable, from the viewpoints of charging characteristics and fluidity, it is preferable to use positively chargeable silica particles as the particles (c).

Moreover, in the case where the silica particles (b) are positively chargeable, it is also possible to use negatively chargeable silica particles.

The average primary particle diameter of the positively chargeable silica particles is not particularly limited so long as the advantage of the invention is not remarkably impaired but is usually 30 nm or less, preferably 25 nm or less, further preferably 20 nm or less, and particularly preferably 15 nm or less. On the other hand, the diameter is usually 5 nm or more, preferably 6 nm or more, and further preferably 7 nm or more. When the average primary particle diameter is too small, the embedding into the toner base particles becomes remarkable, so that an expected improvement in the charge quantity is not obtained and fogging may occur. When the average primary particle diameter is too large, the positively chargeable silica particles themselves are likely to detach from the toner base particles and the member contamination may be caused. Moreover, the positively chargeable silica particles are preferably surface-treated silica particles and a surface treating agent is not particularly limited so long as it has a positively chargeable property but particularly, silica particles treated with an aminosilane coupling agent are preferable. Specific examples of the positively chargeable silica particles include H3OTA (manufactured by Wacker Chemical Company) and the like.

As the above melamine-based resin particles, in addition to a so-called melamine/formaldehyde condensed resin, a melamine/urea/formaldehyde co-condensed resin, a melamine/benzoguanamine/formaldehyde co-condensed resin, and the like may be targeted so long as melamine is used as the main component.

The average primary particle diameter of the melamine-based resin particles is preferably 80 nm or more, more preferably 120 nm or more, and particularly preferably 150 nm or more. Moreover, it is preferably 300 nm or less, more preferably 270 nm or less, and particularly preferably 250 nm or less. When the average primary particle diameter is too small, the adhesion to the toner base particles tends to be too strong, and there may be a case where the expected improvement of the charge quantity is not obtained and fogging occurs. When the diameter is too large, the melamine-based resin particles themselves tend to detach from the toner base particles and may cause member contamination, similarly to the above positively chargeable silica particles.

The average primary particle diameter of the particles (c) is measured by the method to be described in Examples.

The addition amount of the particles (c) is preferably 0.5 parts by mass or less, more preferably 0.4 parts by mass or less, and particularly preferably 0.3 parts by mass or less relative to 100 parts by mass of the toner base particles. Moreover, the amount is preferably 0.05 parts by mass or more and particularly preferably 0.10 parts by mass or more. When the addition amount is too large, the excessive reversely charged particles tend to lower the charge quantity of the toner, whereby fogging may occur. When the addition amount is too small, the reversely charging effect at the time of detachment of the particles (c) from the matrix particles is not sufficiently obtained, and fogging may occur due to a decrease in the charge quantity of the toner. Moreover, when the addition amount is too small in the case where the reversely charged particles act also as a fluidity improver, a decrease in tonner fluidity is invited and thus cleaning failure may occur. Also for reducing the toner consumption, it is important to suppress fogging and to control the toner fluidity so as to be appropriately responsive to the regulation of the toner supply at the machine side.

The method for producing the particles (c) is not particularly limited and can be prepared by known methods but the particles (c) are preferably produced by a dry method. The dry method herein refers to a general production method by a reaction in a vapor phase, such as a method of flame hydrolysis of a silicon compound, a method of oxidation by a method of combustion in a flame, or a method of combined use of these reactions.

<Other Constitution of Toner base particles and Production Method Thereof>

The volume median diameter of the toner base particles of the invention is not particularly limited but, is usually 3 μm or more, preferably 4 μm or more, and more preferably 5 μm or more. Moreover, the diameter is usually 10 μm or less, preferably 8 μm or less, and further preferably 7 um or less. When the volume median diameter of the toner is too large, the charge quantity per unit weight tends to be small, and the possibility of generation of fogging and toner scattering may increase. When the diameter is too small, the charge quantity per unit weight tends to be excessive and troubles such as an extreme image density decrease may be likely to occur. The volume median diameter is measured by the method to be described in Examples.

The average circularity of the toner base particles of the invention is usually 0.950 or more and preferably 0.955 or more. Moreover, the circularity is preferably 0.985 or less and preferably 0.980 or less. When the circularity is too high, pass-through at the cleaning section is likely to occur and thus image failure may occur. On the other hand, the circularity is too low, the external additive may fall into concaves of the matrix particles at the time of rolling on the surfaces of the toner base particles owing to mechanical stress in the machine, whereby the advantage of the invention cannot be maintained until the end in some cases. The circularity of the toner base particles of the invention is measured by the method to be described in Examples.

The constituting materials of the toner of the invention are not particularly limited and contains at least a binding resin, a coloring agent, and a wax and, if necessary, a charge control agent and other additives.

The method for producing the toner base particles of the invention is not limited, and a conventional method may be used such as a pulverization method, a wet method, or a method of spheroidizing the toner by mechanical impact force, thermal treatment, or the like. The wet method may include methods such as a suspension polymerization method, an emulsion polymerization aggregation method, a dissolution suspension method, and an ester extension method.

In the case of the pulverization method, the binder resin, the coloring agent and, as the case requires, other components are weighed in prescribed amounts, blended and mixed. Examples of the mixing apparatus include a double-cone mixer, a V-type mixer, a drum-type mixer, a super mixer, a Henschel mixer, and a Nauta mixer.

Then, the above blended and mixed toner raw material is melt-kneaded to melt the resins and to disperse the coloring agent, and the like therein. In such a melt-kneading step, for example, it is possible to employ a batch-type kneader such as a pressure kneader or a Banbury mixer, or a continuous type kneader. As the kneader, a single-screw or twin-screw extruder may be employed. For example, a KTK-type twin-screw extruder manufactured by Kobe Steel, Ltd., a TEM-type twin-screw extruder manufactured by Toshiba Machine Co., Ltd., a twin-screw extruder manufactured by KCK, or a co-kneader manufactured by Buss may be mentioned. Further, a colored resin composition obtained by melt-kneading the toner raw material is rolled by a twin-roller or the like after the melt-kneading and then cooled via a cooling step of cooling by water cooling or the like.

The cooled product of the colored resin composition obtained as described above is then pulverized to a desired particle diameter in a pulverization step. In the pulverization step, the cooled product is first roughly pulverized by a crusher, a hammer mill, a feather mill, or the like and further pulverized by, for example, a Kriptron system manufactured by Kawasaki Heavy Industries, Ltd. or a super rotor manufactured by Nisshin Engineering Inc. Thereafter, as the case requires, the pulverized product is classified by means of a sieving machine such as a classification machine, such as an elbow jet of an inertial classification system (manufactured by Nittetsu Mining Co., Ltd.) or a turboplex of a centrifugal classification system (manufactured by Hosokawa Micron Corporation), to obtain toner base particles. Furthermore, the toner may be spheroidized by a conventional method.

After the toner base particles are obtained, a toner can be obtained via a treating step of adding an external additive and, as the case requires, the other treating step.

The wet method may include an emulsion polymerization aggregation method, a suspension polymerization method, or a dissolution suspension method, and the production may be carried out by any method without any particular limitation.

In the case where the toner base particles are produced by the emulsion polymerization aggregation method, the production usually includes a polymerization step of polymerizing polymer particles to obtain a polymer particle dispersion, a mixing step of mixing the polymer particle dispersion with a coloring agent particle dispersion and the like, an aggregation step of adding an aggregating agent to the mixed one to aggregate it into a prescribed particle diameter, thereby obtaining particle aggregates (aggregated particles), a fusion step of heating and fusing the aggregated particles to form fused particles, and subsequently steps of taking out a product as toner base particles, such as filtration/washing/drying steps.

In the invention, as the method for producing a suspension polymerization toner, a coloring agent, a polymerization initiator, a wax, and, if necessary, additives such as a charging control agent, and a crosslinking agent are added into the monomer of the binder resin, and uniformly dissolved or dispersed to prepare a monomer composition. Such a monomer composition is dispersed in an aqueous medium containing a dispersion stabilizer and the like. Preferably, the stirring speed and time are adjusted and thus granulation is performed so that liquid droplets of the monomer composition have a desired size of toner particles. Thereafter, polymerization is performed by carrying out stirring to such an extent that the particle state is maintained by the action of the dispersion stabilizer and the precipitation of particles is prevented. These particles are collected by washing and filtration, and toner base particles can be obtained by drying. After the toner base particles are obtained, a toner can be obtained via a treating step of adding an external additive and, as the case requires, the other treating step.

The dissolution suspension method is a method in which a solution phase obtained by dissolving a binder resin in an organic solvent and adding and dispersing a coloring agent and the like therein is dispersed by means of mechanical shear force in an aqueous phase containing a dispersing agent or the like to form droplets and the organic solvent is removed from the droplets to produce toner particles.

The ester extension polymerization method is a method in which an oily phase containing a wax/a polyester resin/a pigment/etc. dispersed therein and an aqueous phase containing a particle diameter controlling agent and a surfactant added thereto are mixed and emulsified to prepare oil droplets, a polymer resin component is formed on the toner oil droplet surfaces by an extension reaction at the same time when the oil droplets are converged, and the solvent inside the oil droplets is removed to produce toner particles.

In the invention, as the binder resin to be contained in the toner, a resin which is used as a binder resin for conventional toners may suitably be used.

As the binder resin to be used in the case where toner base particles are produced by the pulverization method, there may be mentioned polystyrene, a homopolymer of a substituted styrene, a styrene-based copolymer, acrylic acid, methacrylic acid, a polyester resin, a polyamide resin, an epoxy resin, a xylene resin, a silicone resin, and the like. These resins may be used alone or may be used as a mixture.

As the binder resin to be used in the case where toner base particles are produced by the polymerization method, there may be mentioned vinyl polymerizable monomers capable of radical polymerization. Examples thereof include styrene, a styrene derivative, an acrylic polymerizable monomer, a methacrylic polymerizable monomer, a vinyl ester, a vinyl ether, a vinyl ketone, and the like. These resins may be used alone or may be used as a mixture of two or more kinds thereof.

As a monomer, it is possible to use any polymerizable monomer selected from a polymerizable monomer having an acidic group (hereinafter sometimes referred to simply as an “acidic monomer”), a polymerizable monomer having a basic group (hereinafter sometimes referred to simply as a “basic monomer”), and a polymerizable monomer having no acidic or basic group (hereinafter sometimes referred to as an “other monomer”).

Among the polymerization methods mentioned above, in the case where the toner base particles are produced using the emulsion polymerization aggregation method, in the emulsion polymerization step, polymerizable monomers are polymerized in an aqueous medium usually in the presence of an emulsifier. On this occasion, when polymerizable monomers are supplied to the reaction system, the respective monomers may be separately added, or a plurality of monomers may preliminarily be mixed and simultaneously added. Moreover, the monomers may be added as they are, or may be added in the form of an emulsion as preliminarily mixed and prepared with water, an emulsifier, etc.

As the acidic monomer, there may be mentioned a polymerizable monomer having a carboxyl group, such as acrylic acid, methacrylic acid, maleic acid, fumaric acid, or cinnamic acid, a polymerizable monomer having a sulfonic acid group, such as sulfonated styrene, or a polymerizable monomer having a sulfonamide group, such as vinylbenzenesulfonamide, and the like. As the basic monomer, there may be mentioned an aromatic vinyl compound having an amino group, such as aminostyrene, a nitrogen-containing hetero ring-containing polymerizable monomer such as vinylpyridine or vinylpyrrolidone, or a (meth)acrylic acid ester having an amino group, such as dimethylaminoethyl acrylate or diethylaminoethyl methacrylate. These acidic monomers and basic monomers may be used alone, or a plurality of them may be used as a mixture. Otherwise, they may be present in the form of a salt with a counter ion. In particular, it is preferred to employ an acidic monomer, and more preferred is acrylic acid and/or methacrylic acid.

The total amount of the acidic monomer and the basic monomer in 100 parts by mass of all polymerizable monomers constituting the binder resin is usually 0.05 parts by mass or more, preferably 0.5 parts by mass or more, and particularly preferably 1.0 part by mass or more. Moreover, the amount is usually 10 parts by mass or less and preferably 5 parts by mass or less.

As other polymerizable monomers, there may be mentioned a styrene such as styrene, methyl styrene, chlorostyrene, dichlorostyrene, p-tert-butyl styrene, p-n-butylstyrene, or p-n-nonylstyrene, an acrylic acid ester such as methyl acrylate, ethyl acrylate, propyl acrylate, n-butyl acrylate, isobutyl acrylate, hydroxyethyl acrylate, or 2-ethylhexyl acrylate, a methacrylic acid ester such as methyl methacrylate, ethyl methacrylate, propyl methacrylate, n-butyl methacrylate, isobutyl methacrylate, hydroxyethyl methacrylate, or 2-ethylhexyl methacrylate, acrylamide, N-propylacrylamide, N,N-dimethylacrylamide, N,N-dipropylacrylamide, N,N-dibutylacryl amide, and the like. The polymerizable monomers may be used alone, or a plurality of them may be used in combination.

Furthermore, in the case where the binder resin is a crosslinkable resin, together with the above-described polymerizable monomers, a radical-polymerizable polyfunctional monomer is used, and examples thereof include divinylbenzene, hexanediol diacrylate, ethylene glycol dimethacrylate, diethylene glycol dimethacrylate, diethylene glycol diacrylate, triethylene glycol diacrylate, neopentyl glycol dimethacrylate, neopentyl glycol diacrylate, diallyl phthalate, and the like. Moreover, it is also possible to use a polymerizable monomer having a reactive group in a pendant group, such as glycidyl methacrylate, methylol acrylamide, or acrolein. Among them, a radical-polymerizable bifunctional polymerizable monomer is preferred, and divinylbenzene or hexanediol diacrylate is particularly preferred. These polyfunctional polymerizable monomers may be used alone, or a plurality of them may be used as a mixture.

In the case where a binder resin is formed through polymerization by the emulsion polymerization aggregation method, a known surfactant may be used as the emulsifier. As the surfactant, one or two or more surfactants selected from a cationic surfactant, an anionic surfactant, and a nonionic surfactant may be used in combination.

Examples of the cationic surfactant include dodecylammonium chloride, dodecylammonium bromide, dodecyltrimethylammonium bromide, dodecylpyridinium chloride, dodecylpyridinium bromide, and hexadecyltrimethylammonium bromide, and examples of the anionic surfactant include a fatty acid soap such as sodium stearate or sodium dodecanoate, sodium dodecyl sulfate, sodium dodecylbenzenesulfonate, and sodium lauryl sulfate. Examples of the nonionic surfactant include polyoxyethylene dodecyl ether, polyoxyethylene hexadecyl ether, polyoxyethylene nonylphenyl ether, polyoxyethylene lauryl ether, polyoxyethylene sorbitan monooleate ether, monodecanoylsucrose, and the like.

The amount of the emulsifier to be used in the case where the toner base particles are produced using the emulsion polymerization aggregation method is not particularly limited but is preferably 0.1 parts by mass or more and 10 parts by mass or less, relative to 100 parts by mass of the polymerizable monomers. Further, together with the emulsifier, one or two or more of polyvinyl alcohols such as partially or completely saponified polyvinyl alcohols and cellulose derivatives such as hydroxyethyl cellulose may be used in combination as protective colloid.

The volume average particle diameter of primary particles of the polymer obtained by the emulsion polymerization aggregation method is usually 0.02 μm or more, preferably 0.05 μm or more, and particularly preferably 0.1 μm or more. Desirably, the diameter is usually 3 μm or less, preferably 2 μm or less, and particularly preferably 1 μm or less. When the particle diameter is too small, control of the aggregation rate may become difficult in the aggregation step. When the diameter is too large, the particle diameter of toner particles obtained by aggregation tends to be large and it sometimes becomes difficult to obtain a toner having the objective particle diameter.

In the case where the toner base particles are produced using the emulsion polymerization aggregation method, a known polymerization initiator may be used as the case requires, and one or a combination of two or more of the polymerization initiators may be used. For example, a persulfate such as potassium persulfate, sodium persulfate, or ammonium persulfate, and a redox initiator having such a persulfate as one component combined with a reducing agent such as acidic sodium sulfite; a water-soluble polymerization initiator such as hydrogen peroxide, 4,4′-azobiscyanovaleric acid, t-butyl hydroperoxide, or cumene hydroperoxide, and a redox initiator having such a water-soluble polymerization initiator as one component combined with a reducing agent such as a ferrous salt; benzoyl peroxide, 2,2′-azobisisobutyronitrile, or the like may be used. Such a polymerization initiator may be added to the polymerization system at any time, i.e., before, during or after the addition of the monomer, and if necessary, these methods for addition may be used in combination.

In the case where the toner base particles are produced using the emulsion polymerization aggregation method, a known chain transfer agent may be used as the case requires. Specific examples thereof include t-dodecylmercaptan, 2-mercaptoethanol, diisopropylxanthogen, carbon tetrachloride, trichlorobromomethane, and the like. The chain transfer agents may be used alone or in combination as a mixture of two or more of them, and may be used in an amount of 0 to 5% by mass based on the polymerizable monomers.

In the case where the toner base particles are produced using the emulsion polymerization aggregation method, a known suspension stabilizer may be used as the case requires. Specific examples of the suspension stabilizer include calcium phosphate, magnesium phosphate, calcium hydroxide, magnesium hydroxide, and the like. They may be used alone or in combination as a mixture of two or more of them. The suspension stabilizer may be used in an amount of 1 part by mass or more and 10 parts by mass or less relative to 100 parts by mass of the polymerizable monomers.

Any of the polymerization initiator and the suspension stabilizer may be added to the polymerization system at any time, i.e., before, during, or after the addition of the polymerizable monomers, and if necessary, these methods for addition may be used in combination.

In addition, to the reaction system, a pH-controlling agent, a polymerization degree-controlling agent, a defoaming agent, and the like may be suitably added.

To the toner of the invention, it is preferred to incorporate a wax to impart releasability. As such a wax, any wax may be used so long as it has releasability.

Specifically, for example, there may be mentioned an olefinic wax such as a low-molecular-weight polyethylene, a low-molecular-weight polypropylene, or a copolymerized polyethylene; paraffin wax; an ester-based wax having a long-chain aliphatic group, such as behenyl behenate, a montanate ester, or stearyl stearate; a vegetable wax such as hydrogenated castor oil or carnauba wax; a ketone having a long-chain alkyl group such as distearyl ketone; a silicone having an alkyl group; a higher fatty acid such as stearic acid; a long-chain aliphatic alcohol such as eicosanol; a carboxylic acid ester or partial ester of a polyhydric alcohol, obtainable from a polyhydric alcohol such as glycerol or pentaerythritol and a long-chain fatty acid; a higher fatty acid amide such as oleic amide or stearic amide; a low-molecular-weight polyester; and the like.

Among these waxes, in order to improve the fixability, the melting point of the wax is usually 30° C. or higher, preferably 40° C. or higher, and particularly preferably 50° C. or higher. Moreover, the melting point is usually 100° C. or lower, preferably 90° C. or lower, and particularly preferably 80° C. or lower. When the melting point is too low, the wax is likely to leach out on the surface after the fixing and may cause stickiness. On the other hand, when the melting point is too high, the fixability at a low temperature may be poor in some cases.

Moreover, as a compound species of the wax, a higher fatty acid ester-based wax is preferred. Specifically, the higher fatty acid ester wax is preferably an ester of a fatty acid having 15 to 30 carbon atoms with a monohydric to pentahydric alcohol, such as behenyl behenate, stearyl stearate, a stearic acid ester of pentaerythritol, or montanic acid glyceride. Further, the alcohol component constituting the ester is preferably one having 10 to 30 carbon atoms in the case of a monohydric alcohol or one having 3 to 10 carbon atoms in the case of a polyhydric alcohol.

The above waxes may be used alone or as a mixture. Depending on the fixing temperature at which the toner is fixed, the melting point of the wax compound may be suitably selected.

In the invention, the amount of the wax is not particularly limited but is usually 1 part by mass or more, preferably 2 parts by mass or more, and particularly preferably 5 parts by mass or more relative to 100 parts by mass of the toner. Moreover, the amount is usually 40 parts by mass or less, preferably 35 parts by mass or less, and particularly preferably 30 parts by mass or less. When the wax content in the toner is too low, the performance such as a high-temperature offset property may not be sufficient, and on the other hand, when the content is too high, the blocking resistance tends to be inadequate, or the wax may leach out from the toner to soil the apparatus in some cases.

As the coloring agent of the invention, a known coloring agent can be used as will. Specific examples of the coloring agent include carbon black, aniline blue, phthalocyanine blue, phthalocyanine green, hansa yellow, a rhodamine-based dye or pigment, chromium yellow, quinacridone, benzidine yellow, rose bengal, a triallylmethane-based dye, a monoazo-, disazo-, or condensed azo-based dye or pigment, and the like. Known any dyes and pigments may be used alone or as a mixture. In the case of a full-color toner, as a yellow coloring agent, benzidine yellow, or a monoazo- or condensed azo-base dye or pigment is preferably employed, as a magenta coloring agent, quinacridone or a monoazo-based dye or pigment is preferably employed, and as a cyan coloring agent, phthalocyanine blue is preferably employed. The coloring agent is preferably used in such an amount of 3 parts by mass or more and 20 parts by mass or less relative to 100 parts by mass of the polymer primary particles.

In the emulsion polymerization aggregation method, the coloring agent is incorporated usually in the aggregation step. A dispersion of the polymer primary particles and a dispersion of coloring agent particles are mixed to obtain a mixed dispersion, which is then aggregated to obtain particle aggregates. The coloring agent is preferably used in a dispersed state in water in the presence of an emulsifier, and the volume average particle diameter of the coloring agent particles is usually 0.01 μm or more, preferably 0.05 μm or more and usually 3 μm or less, preferably 1 mm or less.

In the invention, a charge control agent may be used as the case require. In the case where the charge control agent is used, known optional ones may be used alone or in combination. Examples of a positively chargeable charge control agent include a quaternary ammonium salt, an azine-based black dye such as nigrosine, a processed nigrosine, or an alkylnigrosine, a processed nigrosine compound, a guanidine compound, a triphenylsulfonium compound, a resin-based charge control agent, an amide group-containing compound, and a basic/electron donating metal substance. Examples of a negatively chargeable charge control agent include an aromatic oxycarboxylic acid-based one, a metal chelate of an aromatic dicarboxylic acid, a monoazo metal-containing complex compound, a metal salt of an organic acid, a metal-containing dye, a diphenylhydroxy complex compound, an iron-containing azo compound, a charge control agent for emulsion polymerization, various metal complex compounds of oxycarboxylic acids, a calixarene compound, a phenol compound, a resin-based charge control agent, a naphthol compound or a metal salt thereof, a urethane bond-containing compound, and an acidic or electron-withdrawing organic substance.

Moreover, in the case where the toner of the invention is used as a toner other than a black toner in a color toner or full-color toner, it is preferred to employ a colorless or pale colored charge control agent free from color tone hindrance to the toner. For example, as a positively chargeable charge control agent, a quaternary ammonium salt compound is preferred, and as a negative chargeable charge control agent, a metal salt or metal complex of salicylic acid or alkyl salicylate with zinc, aluminum or the like, a metal salt or metal complex of benzylic acid, an amide compound, a phenol compound, a naphthol compound, a phenolamide compound, or a hydroxynaphthalene compound such as 4,4′-methylenebis [2-[N-(4-chlorophenyl)amide]-3-hydroxynaphthalene] is preferred.

In the toner of the invention, in the case where a charge control agent is incorporated to the toner by an emulsion polymerization aggregation method, the charge control agent may be added together with the polymerizable monomers, and the like during the emulsion polymerization, or it may be added in the aggregation step together with the polymer primary particles, the coloring agent, and the like, or it may be blended by a method of adding it after the polymer primary particles, the coloring agent, and the like are aggregated to have substantially the objective particle diameter. Of these methods, it is preferred to disperse the charge control agent in water by means of a surfactant and to add the resultant dispersion having a volume average particle diameter of 0.01 μm or more and 3 μm or less in the aggregation step.

In the emulsion polymerization aggregation method, aggregation is usually carried out in a tank provided with a stirring device, and it may be carried out by a heating method, a method of adding an electrolyte, or a combination of these methods. In the case where polymer primary particles are aggregated under stirring to obtain particle aggregates having an objective size, the particle diameter of the particle aggregates is controlled by the balance between the cohesive force among particles and the shearing force by the stirring, and the cohesive force can be increased by heating or by adding an electrolyte. In the case where aggregation is carried out by adding an electrolyte in the invention, such an electrolyte may be either an organic salt or an inorganic salt. Specifically, there may be mentioned NaCl, KCl, LiCl, Na₂SO₄, K₂SO₄, Li₂SO₄, MgCl₂, CaCl₂, MgSO₄, CaSO₄, ZnSO₄, Al₂(SO₄)₃, Fe₂(SO₄)₃, CH₃COONa, C₆H₅SO₃Na, and the like. Of these, an inorganic salt having a bivalent or higher valent metal cation is preferred.

In the toner of the invention, the addition amount of the electrolyte varies depending on the type of the electrolyte, the objective particle diameter, and the like, but it is usually 0.05 parts by mass or more, preferably 0.1 parts by mass or more relative to 100 parts by mass of the solid component of the mixed dispersion. Moreover, the amount is usually 25 parts by mass or less, preferably 15 parts by mass or less, and particularly preferably 10 parts by mass or less. When the addition amount is too small, the progress of the aggregation reaction tends to be slow, whereby there may arise such a problem that a fine powder of 1 μm or less remains after the aggregation reaction or the average particle diameter of the resultant particle aggregates does not reach the objective particle diameter. On the other hand, when the amount is too large, the aggregation tends to be rapid, whereby there may arise such a problem that control of the particle diameter becomes difficult or coarse particles or irregular particles tend to be contained in the resultant aggregated particles. The aggregation temperature in the case of carrying out the aggregation by adding an electrolyte, is usually 20° C. or higher and preferably 30° C. or higher and is usually 70° C. or lower and preferably 60° C. or lower.

In the case where the aggregation is carried out only by heating without using an electrolyte, the aggregation temperature is usually (Tg-20)° C. or higher and preferably (Tg-10)° C. or higher, taking the glass transition temperature of the polymer primary particles as Tg. Moreover, the aggregation temperature is usually Tg or lower and preferably (Tg-5)° C. or lower.

The time required for aggregation is optimized by the shape of the apparatus or the scale of the treatment but, in order to bring the particle diameter of the toner into the objective particle diameter, it is usually preferred to maintain the system at the aforementioned prescribed temperature for at least 30 minutes or more. The temperature may be raised to the prescribed temperature at a constant rate or may be raised stepwise.

As the case requires, it is also possible to form particles in which resin particles are adhered or fixed to the surfaces of the particle aggregates after the above-described aggregation treatment. By adhering or fixing resin particles having controlled properties to the surfaces of the particle aggregates, there are cases where the chargeability and heat resistance of the resultant toner can be improved, and further, the advantage of the invention can be made more conspicuous.

In the case where resin particles having a glass transition temperature higher than the glass transition temperature of the polymer primary particles are used as the resin particles, a further improvement of blocking resistance can be realized without impairing the fixability, so that the case is preferred. The volume average particle diameter of the resin particles is usually 0.02 μm or more and preferably 0.05 μm or more, and is usually 3 μm or less and preferably 1.5 μm or less. As the resin particles, for example, it is possible to use the ones obtained by emulsification polymerization of the same monomer as the polymerizable monomer to be use for the aforementioned polymer primary particles.

The resin particles are usually employed in the form of a dispersion as dispersed in water or a liquid containing water as the main component by means of a surfactant. In the case where a charge control agent is added after the aggregation treatment, it is preferred to add the resin particles after adding the charge control agent to the dispersion containing particle aggregates.

In order to increase the stability of the particle aggregates obtained in the aggregation step, it is preferred to carry out fusion among the particle aggregates in an aging step after the aggregation step. The temperature in the aging step is usually Tg of the polymer primary particles or higher, preferably a temperature higher by 5° C. than Tg or higher and usually a temperature higher by 80° C. than Tg or lower, preferably a temperature higher by 50° C. than Tg or lower. Moreover, the time required for the aging step varies depending on the objective shape of the toner, but after the temperature has reached the glass transition temperature of the polymer primary particles or higher, it is desired to maintain the temperature usually for 0.1 to 10 hours, preferably for 1 to 6 hours.

Incidentally, after the aggregation step, preferably before the aging step or during the aging step, it is preferred to add a surfactant or to increase the pH value. As the surfactant to be used here, at least one member may be selected for use from emulsifiers which may be used at the time of producing the polymer primary particles, but it is preferred to employ the same emulsifier as the one used for the production of the polymer primary particles. In the case of adding the surfactant, the addition amount is not particularly limited but is usually 0.1 parts by mass or more, preferably 1 part by mass or more, and particularly preferably 3 parts by mass or more relative to 100 parts by mass of the solid component in the mixed dispersion. Moreover, the amount is usually 20 parts by mass or less, preferably 15 parts by mass or less, and particularly preferably 10 parts by mass or less. By adding the surfactant or increasing the pH value after the aggregation step and before completion of the aging step, it may be possible to suppress the aggregation of the particle aggregates aggregated in the aggregation step and to suppress formation of coarse particles after the aging step in some cases.

By the heat treatment in the aging step, fusion and integration of the polymer primary particles are carried out in the aggregates, whereby the shape of the toner particles as the aggregates becomes close to a spherical shape. The particle aggregates before the aging step are considered to be an assembly by electrostatic or physical aggregation of the polymer primary particles, but after the aging step, the polymer primary particles constituting the particle aggregates are considered to be mutually fused, and the shape of the toner particles can be made close to a spherical shape. According to such an aging step, by controlling the temperature, time, and the like of the aging step, it is possible to produce toners having various shapes depending on the purpose, e.g., a grape type having a shape of aggregation of polymer primary particles, a potato type having a shape of advanced fusion, and a spherical type having a shape of further advanced fusion.

The obtained particles are subjected to solid-liquid separation by a known method to recover the particles, which are, as the case requires, washed and dried, and thereby, objective toner base particles can be obtained.

### <External Addition Step>

The toner of the invention is obtained by externally adding the silica particles (a) prepared by the aforementioned fusion method, the silica particles (b), and the particles (c) to be charged to have a reverse polarity to that of the silica particles (b), to the surfaces of the toner base particles. However, within the range where the advantage of the invention is not impaired, particles (d) that are known as another external additive and exemplified below may be used in combination and added to the toner base particles to adhere or fix them to the surfaces of the toner base particles.

Examples of the particles (d) other than the silica particles (a) prepared by the aforementioned fusion method, the silica particles (b), and the particles (c) include titania, aluminum oxide (alumina), zinc oxide, tin oxide, barium titanate, strontium titanate, hydrotalcite, and the like as inorganic particles and organic acid salt particles such as zinc stearate and calcium stearate, organic resin particles such as methacrylate ester polymer particles, acylate ester polymer particles, styrene-methacrylate ester copolymer particles, and styrene-acrylate ester copolymer particles, and the like as organic particles.

The blend ratio of the silica particles (a) prepared by the aforementioned fusion method, the silica particles (b), the particles (c), and the particles (d) is not particularly limited and the amount of the whole external additives composed of the silica particles (a) prepared by the aforementioned fusion method, the silica particles (b), the particles (c), and the particles (d) is not particularly limited but, the amount of the whole external additives is usually 1.3 parts by mass or more and preferably 1.4 parts by mass or more relative to 100 parts by mass of the toner base particles. On the other hand, the amount is usually 5.5 parts by mass or less and preferably 5.0 parts by mass or less. When the amount is too small, the external additives are remarkably embedded into the surfaces of the matrix particles and fogging may get worse. On the other hand, when the amount is too large, image defects caused by passing through the cleaning blades may occur due to excessive fluidity.

As for the above particles (d), the order of adhering or fixing them to the surfaces of the toner base particles is not particularly limited but the particles may be used in combination with the silica particles (a) prepared by the aforementioned fusion method, the silica particles (b), or the particles (c) or may be separately added without combining them.

In the invention, the method of adhering or fixing the silica particles (a) prepared by the aforementioned fusion method, the silica particles (b), the particles (c), and the particles (d) to the surfaces of the toner base particles is not particularly limited and a mixer to be commonly used for the production of a toner can be employed. Specifically, the method may be carried out by stirring and mixing by means of a mixer such as a Henschel mixer, a V-type blender, a Lödige mixer, or a Q-mixer.

### EXAMPLES

The invention will be described more specifically with reference to Examples, but the invention is by no means restricted to the following Examples so long as it does not exceed the gist thereof. In the following examples, “parts” means “parts by mass” and “%” means “% by mass”.

### <Method for Measuring Average Particle Diameter of Polymer Primary Particles>

Using Model: Microtrac Nanotrac 150 (hereinafter abbreviated as “Nanotrac”) manufactured by Nikkiso Co., Ltd., in accordance with the handling manual of Nanotrac, the average particle diameter was measured by the method described in the handling manual using the analysis soft Microtrac Particle Analyzer Ver 10.1.2.-019EE and using, as a dispersion medium, ion-exchanged water having an electric conductivity of 0.5 μS/cm under the following conditions or while inputting the following conditions:
Refractive index of solvent: 1.333
Measuring time: 100 seconds
Number of measuring times: Once
Refractive index of particles: 1.59
Permeability: Permeable
Shape: Spherical shape
Density: 1.04

### <Method for Measuring Volume Median Diameter (Dv50) of Toner Particles>

The volume median diameter was measured by means of Multisizer III (aperture diameter: 100 μm) (hereinafter abbreviated as “Multisizer”) manufactured by Beckman Coulter, Inc. using, as a dispersion medium, Isoton II manufactured by the same company and dispersing the toner particles so that the dispersoid concentration became 0.03% by mass. The range of particle diameters to be measured was set to be from 2.00 to 64.00 μm, and this range was made discrete into 256 divisions with equal distances by a logarithmic scale, whereby one calculated on the basis of their volume-based statistical values was taken as a volume median diameter (Dv50).

### <Method for Measuring Circularity>

The “average circularity” in the invention was measured by dispersing toner base particles in a dispersion medium (Isoton II, manufactured by Beckman Coulter, Inc.) so that its concentration fell within a range of 5,720 to 7,140 particles/μl and by using a flow-type particle image analyzer (FPIA3000, manufactured by Sysmex Corporation (formerly, Toa Medical Electronics Co., Ltd.)) under the following apparatus conditions, and the value is defined as “average circularity”. In the invention, the same measurement is performed three times and an arithmetical mean value of the three values of the “average circularity” is adopted as “average circularity”.
Mode: HPF
HPF analytical amount: 0.35 μl
Number of pieces on HPF detection: 2,000 to 2,500 particles

The following are those measured on the above analyzer and automatically calculated and shown in the analyzer. The “circularity” is defined by the following formula.

[Circularity] =[Circumference of circle having the same area as projected area of particle]/[Circumference of projected image of particle]

Thus, 2,000 to 2,500 particles that are the number of pieces on HPF detection are measured and an arithmetical mean of the values of circularity of individual particles is shown on the analyzer as “average circularity”.

### <Method for Measuring Glass Transition Temperature (Tg) of Core Resin and Shell Resin of Matrix Particles>

The glass transition temperature was measured by means of DSC7 manufactured by PerkinElmer Co., Ltd. Ten milligrams of a sample was put into an aluminum pan, heated from 30° C. to 100° C. over a period of 7 minutes, rapidly cooled from 100° C. to -20° C., and then heated from −20° C. to 100° C. over a period of 12 minutes, and a Tg value observed at the second temperature elevation was used. In the ease where a plurality of endothermic peaks are present, the lowest endothermic peak temperature is taken as Tg. Incidentally, the core resin and the shell resin are measured after the water content in the dispersion is removed to dryness and, in the case where the endothermic peak of the wax particles interferes, a polymer having no wax particles is prepared and measured.

### <Method for Measuring Average Primary Particle Diameter of External Additive>

The average primary particle diameter of the external additive of the invention can be measured using a transmission electron microscope image. For example, there are a method of randomly selecting several thousands of particles from the target external additive on the transmission electron microscope image and determining an average primary particle diameter by averaging the particle diameters thereof and a method of determining a sphere-converted equivalent diameter from measured values of BET specific surface area.

### <Method for Measuring BET Specific Surface Area of External Additive and Toner>

The BET specific surface area is measured by one point method using Macsorb model-1208 manufactured by Mountech Co., Ltd. and using liquid nitrogen. Specifically, it is measured as follows.

First, a sample to be measured is packed in an amount of about 1.0 g into a dedicated cell made of glass (hereinafter, the amount of the packed sample is shown as A (g)). Then, the cell is set on a measuring device main body and, after drying and deaeration are performed at 200° C. for 20 minutes under a nitrogen atmosphere, the cell is cooled to room temperature. Thereafter, while the cell is cooled with liquid nitrogen, a measuring gas (a mixed gas of 30% of first-grade nitrogen and 70% helium) is allowed to flow in the cell at a flow rate of 25 mL/min and an amount V (cm³) of the measuring gas absorbed on the sample is measured. When total surface area of the sample is designated as S (m²), the BET specific surface area (m²/g) to be determined can be calculated by the following calculation formula.

$$\begin{matrix}( BET specific surface area ) = S \text{/} A \\ = [ K . ( 1 - P \text{/} P 0 ) . V ] \text{/} A\end{matrix}$$

K: gas constant (4.29 in this measurement)
P/P0: relative pressure of the absorbable gas and 97% of the mixing ratio (0.29 in this measurement)

### <Method for Measuring Charge Quantity>

The measurement of charge quantity of inorganic particles in the invention is performed under the following conditions.

Under an environment of a temperature of 23° C. and a humidity of 55%,
Carrier: 19.8 g of non-coat ferrite carrier (particle diameter of 80 pm, manufactured by Powdertech Co., Ltd.) Inorganic powders: 0.2 g are put into a 20 ml glass bottle and left to stand for at least 12 hours. Thereafter, they were mixed by hand shaking for 50 reciprocations, followed by stirring with an amplitude of 1.0 cm at a shaking speed of 500 rpm for 1 minute.

From the glass bottle, 0.2 g was taken out and measured by means of Blowoff TB-200 apparatus manufactured by Toshiba Chemical Corporation under the following settings:
N₂ pressure meter: 1.0 kg/cm²
SET TIME: 20.0 sec
Metal net set at Faraday gauge (made of stainless steel: 400 mesh)

With respect to the read out value Q (μC), calculation is made by the following calculation formula and thereby the charge quantity per unit mass Q/M (μC/g) can be determined.

Q/M(μC/g)=−(Q(μC)/(Measured mass (g))

### <Method for Measuring True Specific Gravity>

Using a Le Chatelier's specific gravity bottle, the true specific gravity was measured in accordance with JIS-K-0061 (2001) 5.2. The operation was carried out as follows.
(1) Into a Le Chatelier's specific gravity bottle, about 250 ml of ethyl alcohol is put and adjusted so that the meniscus is located at the scale mark position.
(2) The specific gravity bottle is immersed in a constant-temperature water tank, and when the liquid temperature becomes 20.0±0.2° C., the position of the meniscus is accurately read out by the scale marks of the specific gravity bottle. (Precision: 0.025 ml)
(3) About 100 g of a sample is weighed, and its mass is designated as W.
(4) The weighed sample is put into the specific gravity bottle, and bubbles are removed.
(5) The specific gravity bottle is immersed in a constant-temperature water tank, and when the liquid temperature becomes 20.0±0.2° C., the position of the meniscus is accurately read out by scale marks of the specific gravity bottle. (Precision: 0.025 ml)
(6) The true specific gravity is calculated by the following formulae.

D=W/(L2−L1)

S=D/0.9982

In the formulae, D is the density (20° C.) (g/cm³) of the sample, S is the true specific gravity (20° C.) of the sample, W is the apparent mass (g) of the sample, L1 is the read out value (20° C.) (ml) of the meniscus before the sample is put into the specific gravity bottle, L2 is the read out value (20° C.) (ml) of the meniscus after the sample is put into the specific gravity bottle, and 0.9982 is the density (g/cm³) of water at 20° C.

### [Production of Matrix Particles]

### <Preparation of Wax/Long-Chain Polymerizable Monomer Dispersion A1>

27 Parts of paraffin wax (HNP-9, manufactured by Nippon Seiro Co., Ltd.), 2.8 parts of stearyl acrylate (manufactured by Tokyo Chemical Industry Co., Ltd.), 1.9 parts of a 20% aqueous sodium dodecylbenzenesulfonate solution (Neogen S20D, manufactured by DKS Co., Ltd.) (hereinafter abbreviated as “20% aqueous DBS solution”), and 68.3 parts of desalted water were heated to 90° C. and stirred for 10 minutes by means of a homomixer (Mark IIf model, manufactured by Tokushu Kika Kogyo Co., Ltd.). Then, this dispersion was heated to 90° C., circulation emulsification was initiated under a pressure condition of 25 MPa by means of a homogenizer (15-M-8PA model, manufactured by Gaulin), and while measuring the particle diameter by Nanotrac, it was dispersed until the volume average particle diameter (MV) became 250 nm, thereby preparing a wax/long-chain polymerizable monomer dispersion A1 (solid content concentration of emulsion-30.2%)

### <Preparation of Polymer Primary Particle Dispersion A1>

Into a reactor equipped with a stirring device (three blades), a heating/cooling device, a concentrating device, and devices for charging individual raw materials and auxiliaries, 35.6 parts of the wax/long-chain polymerizable monomer dispersion Al and 259 parts of desalted water were charged and heated to 90° C. under a nitrogen stream with stirring.

Thereafter, while stirring was continued, a mixture of the following monomers and aqueous emulsifier solution was added over a period of 5 hours from the initiation of the polymerization. The time when addition of the mixture of the monomers and aqueous emulsifier solution was started, was taken as initiation of the polymerization. After 30 minutes from the initiation of the polymerization, the following aqueous initiator solution was added over a period of 4.5 hours, further, after 5 hours from the initiation of the polymerization, the following additional aqueous initiator solution was added over a period of 2 hours, and the whole was maintained for another 1 hour at an internal temperature of 90° C. while stirring was continued.

### [Monomers]

Styrene 76.8 parts
Butyl acrylate 23.2 parts
Acrylic acid 1.5 parts
Trichlorobromomethane 1.0 part
Hexanediol diacrylate 0.7 parts
[Aqueous Emulsifier Solution]
20% Aqueous DBS solution 1.0 part
Desalted water 67.1 parts
[Aqueous Initiator Solution]
8% Aqueous hydrogen peroxide solution 15.5 parts
8% Aqueous L-(+)-ascorbic acid solution 15.5 parts
[Additional Aqueous Initiator Solution]
8% Aqueous L-(+)-ascorbic acid solution 14.2 parts

After completion of the polymerization reaction, the whole was cooled to obtain a milky white polymer primary particle dispersion Al. When this dispersion was measured by means of Nanotrac, the volume average particle diameter (MV) was 280 nm and the solid content concentration was 21.1%.

### <Production of Matrix Particles A>

Polymer primary particle dispersion A1
   90 parts as solid content
Polymer primary particle dispersion A1
   10 parts as solid content (added later)
Cyan pigment dispersion (EP750 manufactured by Dainichiseika Color & Chemicals Mfg. Co., Ltd.)
   4.4 parts as coloring agent solid content 20% Aqueous DBS solution 0.1 parts as solid content

Using the above respective components, matrix particles were manufactured by the following procedure.

Into a mixer equipped with a stirring device (double helical blades), a heating/cooling device, a concentrating device, and devices for charging individual raw materials and auxiliaries, the polymer primary particle dispersion A1 and the 20% aqueous DBS solution were charged and uniformly mixed at an internal temperature of 12° C. for 5 minutes. Subsequently, while stirring was continued at an internal temperature of 12° C., a 5% aqueous solution of ferrous sulfate was added in an amount of 0.52 parts as FeSO₄.7H₂O over a period of 5 minutes, and then the coloring agent fine particle dispersion A was added over a period of 5 minutes, followed by uniform mixing at an internal temperature of 12° C. Further, under the same conditions, a 0.5% aqueous aluminum sulfate solution was added dropwise (the solid content to the resin solid content: 0.10 parts). Thereafter, the internal temperature was raised to 53° C. over a period of 75 minutes and further raised to 56° C. over a period of 90 minutes. Here, the volume median diameter was measured by means of Multisizer and was found to be 5.2 μm. Thereafter, the polymer primary particle dispersion A1(later adding portion) was added over a period of 3 minutes and then the whole was held for 60 minutes as it was. Subsequently, the 20% aqueous DBS solution (6 parts as the solid content) was added over a period of 10 minutes, and then the temperature was raised to 90° C. over a period of 30 minutes and held for 75 minutes.

Thereafter, the whole was cooled to 30° C. over a period of 20 minutes, and the obtained slurry was withdrawn and subjected to suction filtration by means of an aspirator using a filter paper of No. 5C (No. 5C, manufactured by Toyo Roshi Kaisha, Ltd.). A cake remained on the filter paper was transferred to a stainless steel container equipped with a stirrer (propeller blades) and ion-exchanged water having an electrical conductivity of 1 μS/cm was added, followed by stirring for uniform dispersion. Thereafter, the stirring was continued for 30 minutes.

Thereafter, suction filtration was again carried out by means of an aspirator using a filter paper of No. 5C (No. 5C, manufactured by Toyo Roshi Kaisha, Ltd.), and the solid remained on the filter paper was again transferred to a container equipped with a stirrer (propeller blades) and containing ion-exchanged water having an electrical conductivity of 1 μS/cm, and uniformly dispersed by stirring, and the stirring was continued for 30 minutes. This step was repeated five times, whereupon the electrical conductivity of the filtrate became 2 μS/cm.

The cake thus obtained here was spread on a stainless steel pad so that the height became 20 mm and dried for 48 hours in an air-circulating dryer set at 40° C. to thereby obtain matrix particles A. The volume median diameter of the resultant toner base particles A was 6.3 μm, and the average circularity was 0.960.

In Examples and Comparative Examples, the following silica particles 0 to R and x to z were used.
Silica particles 0: The original material is prepared by a fusion method, and the surface is treated with hexamethyldisilazane. (BET: 32.16 m²/g, true specific gravity: 2.2, negatively chargeable)
Silica particles P: The original material is prepared by a fusion method, and the surface is treated with hexamethyldisilazane. (BET: 25.82 m²/g, true specific gravity: 2.2, negatively chargeable)
Silica particles Q: The original material is prepared by a wet method, and the surface is treated with hexamethyldisilazane. (BET: 36.53 m²/g, true specific gravity: 2.2, negatively chargeable)
Silica particles R: The original material is prepared by a dry method, and the surface is treated with hexamethyldisilazane. (BET: 29.89 m²/g, true specific gravity: 2.2, negatively chargeable)
Silica particles x: The original material is prepared by a dry method, and the surface is treated with hexamethyldisilazane. (BET: 66.67 m²/g, true specific gravity: 2.2, negatively chargeable)
Silica particles y: The original material is prepared by a dry method, and the surface is treated with hexamethyldisilazane. (BET: 42.95 m²/g, true specific gravity: 2.2, negatively chargeable)
Silica particles z: The original material is prepared by a dry method, and the surface is treated with hexamethyldisilazane. (BET: 140.7 m²/g, true specific gravity: 2.2, negatively chargeable)

Incidentally, the silica particles obtained by a fusion method are specifically produced by the method described in, for example, paragraphs [0007] to [0021] of JP-A-2000-247626 and columns of [Constitution of the Invention] and [Action of the Invention] of JP-A-60-255602.

### Example 1

### <Production of Toner A>

To the matrix particles A (100 parts), 0.5 parts of the silica particles 0 prepared by the fusion method, 0.35 parts of the silica particles x, 0.9 parts of titanium oxide (average primary particle diameter: 15 nm, BET specific surface area: 91.0 m²/g, charge quantity: −30.4 μC/g), and 0.225 parts of positively chargeable silica particles (average primary particle diameter: 8 nm, BET specific surface area: 118.8 m²/g, charge quantity: +509.3 μC/g, true specific gravity: 2.2) were added, followed by stirring and mixing with a Henschel mixer at 3,000 rpm for 15 minutes. Upon sieving, a toner A was obtained.

### Example 2

### <Production of Toner B>

A toner B was obtained in the same manner as in Example 1 except that in Example 1, the silica particles P prepared by a fusion method were used instead of the silica particles O prepared by a fusion method.

### Comparative Example 1

### <Production of Toner C>

A toner C was obtained in the same manner as in Example 1 except that in Example 1, the amount of the silica particles O prepared by a fusion method was changed to 0 part.

### Comparative Example 2

### <Production of Toner D>

A toner D was obtained in the same manner as in Example 1 except that in Example 1, the silica particles Q prepared by a wet method were used instead of the silica particles 0 prepared by a fusion method.

### Comparative Example 3

### <Production of Toner E>

A toner E was obtained in the same manner as in Example 1 except that in Example 1, the silica particles R prepared by a dry method were used instead of the silica particles 0 prepared by a fusion method.

### Comparative Example 4

### <Production of Toner F>

A toner F was obtained in the same manner as in Example 1 except that in Example 1, the silica particles y were used instead of the silica particles x.

### Comparative Example 5

### <Production of Toner G>

A toner G was obtained in the same manner as in Example 1 except that in Example 1, the silica particles z were used instead of the silica particles x.

### Comparative Example 6

### <Production of Toner H>

A toner H was obtained in the same manner as in Example 1 except that in Example 1, the amount of the positively chargeable silica particles was changed to 0 part.

Incidentally, Table-1 shows details of external addition formulations of Examples and Comparative Examples and Table-2 shows production methods and physical properties of silica used in each toner and a combination thereof.

TABLE 1

| | | | | | Conditions for | |
|---|---|---|---|---|---|---|
| | | | | | external addition | |
| | | Additives | | Addition | Number of | |
| | | | BET | amount (parts | rotation | |
| | Toner | Type | (m²/g) | by mass) | (rpm) | Time (min) |
| Example 1 | A | Silica x | 66.67 | 0.35 | 3,000 | 15 |
| | | Titanium oxide | 91 | 0.9 | | |
| | | Positively | 118.8 | 0.225 | | |
| | | chargeable silica | | | | |
| | | Large particle | 32.16 | 0.5 | | |
| | | silica O | | | | |
| Example 2 | B | Silica x | 66.67 | 0.35 | 3,000 | 15 |
| | | Titanium oxide | 91 | 0.9 | | |
| | | Positively | 118.8 | 0.225 | | |
| | | chargeable silica | | | | |
| | | Large particle | 25.82 | 0.5 | | |
| | | silica P | | | | |
| Comparative | C | Silica x | 66.67 | 0.35 | 3,000 | 15 |
| Example 1 | | Titanium oxide | 91 | 0.9 | | |
| | | Positively | 118.8 | 0.225 | | |
| | | chargeable silica | | | | |
| | | Large particle | | | | |
| | | silica | | | | |
| Comparative | D | Silica x | 66.67 | 0.35 | 3,000 | 15 |
| Example 2 | | Titanium oxide | 91 | 0.9 | | |
| | | Positively | 118.8 | 0.225 | | |
| | | chargeable silica | | | | |
| | | Large particle | 44.68 | 0.5 | | |
| | | silica Q | | | | |
| Comparative | E | Silica x | 66.67 | 0.35 | 3,000 | 15 |
| Example 3 | | Titanium oxide | 91 | 0.9 | | |
| | | Positively | 118.8 | 0.225 | | |
| | | chargeable silica | | | | |
| | | Large particle | 29.89 | 0.5 | | |
| | | silica R | | | | |
| Comparative | F | Silica y | 42.95 | 0.35 | 3,000 | 15 |
| Example 4 | | Titanium oxide | 91 | 0.9 | | |
| | | Positively | 118.8 | 0.225 | | |
| | | chargeable silica | | | | |
| | | Large particle | 32.16 | 0.5 | | |
| | | silica O | | | | |
| Comparative | G | Silica z | 140.7 | 0.35 | 3,000 | 15 |
| Example 5 | | Titanium oxide | 91 | 0.9 | | |
| | | Positively | 118.8 | 0.225 | | |
| | | chargeable silica | | | | |
| | | Large particle | 32.16 | 0.5 | | |
| | | silica O | | | | |
| Comparative | H | Silica x | 66.67 | 0.35 | 3,000 | 15 |
| Example 6 | | Titanium oxide | 91 | 0.9 | | |
| | | Positively | | | | |
| | | chargeable silica | | | | |
| | | Large particle | 32.16 | 0.5 | | |
| | | silica O | | | | |

TABLE 2

| | | External additives | | | | | | | |
|---|---|---|---|---|---|---|---|---|---|
| | | | | | | | Particles (c) | | |
| | | Silica (a) | | | Silica (b) | | | | Particle |
| | | | Production | BET | | BET | | BET | diameter |
| | Toner | Type | method | (m²/g) | Type | (m²/g) | Type | (m²/g) | (nm) |
| Example 1 | A | O | Fusion | 32.16 | x | 66.67 | Positively | 118.8 | 8 |
| | | | method | | | | chargeable | | |
| | | | | | | | silica | | |
| Example 2 | B | P | Fusion | 25.82 | x | 66.67 | Positively | 118.8 | 8 |
| | | | method | | | | chargeable | | |
| | | | | | | | silica | | |
| Comparative | C | | | | x | 66.67 | Positively | 118.8 | 8 |
| Example 1 | | | | | | | chargeable | | |
| | | | | | | | silica | | |
| Comparative | D | Q | Wet method | 36.53 | x | 66.67 | Positively | 118.8 | 8 |
| Example 2 | | | | | | | chargeable | | |
| | | | | | | | silica | | |
| Comparative | E | R | Dry method | 29.89 | x | 66.67 | Positively | 118.8 | 8 |
| Example 3 | | | | | | | chargeable | | |
| | | | | | | | silica | | |
| Comparative | F | O | Fusion | 32.16 | y | 42.95 | Positively | 118.8 | 8 |
| Example 4 | | | method | | | | chargeable | | |
| | | | | | | | silica | | |
| Comparative | G | O | Fusion | 32.16 | z | 140.7 | Positively | 118.8 | 8 |
| Example 5 | | | method | | | | chargeable | | |
| | | | | | | | silica | | |
| Comparative | H | O | Fusion | 32.16 | x | 66.67 | | | |
| Example 6 | | | method | | | | | | |

### <Evaluation Method>

For the obtained toners, the following evaluation was carried out. Evaluation of Cleaning Properties, White Spots, and Toner Consumption by Actual Printing Test

### 2. Stability Test of Charge Quantity

Table-3 shows evaluation results of 1. and 2. and Table-4 shows details of 2.

### <Method for Actual Printing Test>

For the actual printing test, a full-color printer was employed by using a nonmagnetic two-component contact developing system and an organic photoreceptor (OPC) by roller electrification, at a process speed of 154.0 mm/sec, using a tandem system, an intermediate transfer system, a heat fixation system, and a blade drum cleaning system.

After carrying out printing of a few copies under an environment of 23° C. and 50%, a 6% printing ratio chart was printed up to 2,000 copies in total. In the above printing of 2,000 copies, toner weight was measured and a solid image was printed every printing of 500 copies, and the presence of white spots attributable to toner chargeability was visually confirmed. The judgment standards are as follows.
O: no white spots
Δ: slight white spots are observed but no problem on practical use
x: white spots are observed and troubles are caused on practical use

### <Toner Consumption>

The judgment standards for toner consumption are as follows.
O: average toner consumption per 1,000 copies is less than 18 g
Δ: average toner consumption per 1,000 copies is 18 g or more and less than 19 g
x: average toner consumption per 1,000 copies is 19 g or more

### <Stability Test of Charge Quantity>

A ferrite core carrier (BET specific surface: 0.36 m²/g, fluidity: 42.8 sec/50 g) whose surface was covered with a silicone coating agent and a toner are mixed in a plastic bag so that the toner concentration becomes 6% by weight, and hand shaking is carried out up and down ten times. Thereafter, the sample was charged into a micro-shape see-through type mixer W-1-12971 manufactured by Tokyo Tsutsui Scientific Instruments Co., Ltd. Taito, and mixing was started. A developer was sampled every two minutes until a mixing time of 10 minutes and charge quantity was measured by means of a charge quantity distribution meter (manufactured by Etwas). Evaluation was performed by comparing the obtained values of charge quantity (Q2 min to Q10 min). The mixing time of 0 min in Table-4 means a value immediately after the hand shaking, which is excluded from judgment.

The judgment standards are as follows.
Charging stability
O: standard deviation of Q2 min to Q10 min is less than 1.50
Δ: standard deviation of Q2 min to Q10 min is 1.50 or more and less than 2.50
x: standard deviation of Q2 min to Q10 min is 2.50 or more
   Average charge quantity
O: arithmetical mean of Q10 min to Q2 min>−25 μc/g
Δ: −30 μc/g≦Q10 min-Q2 min-25 μc/g
x: arithmetical mean of Q10 min to Q2 min<−30 μc/g

TABLE 3

| | | | | | Mixing test | | | |
|---|---|---|---|---|---|---|---|---|
| | | Actual printing test | | | Charging | | Average | |
| | | | TC | | stability | | charge | |
| | | White spots | (g/kp) | | standard | | quantity | |
| | Toner | (on solid print) | avg. | | deviation | | (−μc/g) | |
| Example 1 | A | ◯ | 17.5 | ◯ | 1.39 | ◯ | 24.7 | ◯ |
| Example 2 | B | ◯ | 17.0 | ◯ | 1.25 | ◯ | 24.2 | ◯ |
| Comparative | C | X | 16.0 | ◯ | 3.81 | X | 31.7 | X |
| Example 1 | | | | | | | | |
| Comparative | D | Δ | 18.4 | Δ | 3.15 | X | 29.2 | Δ |
| Example 2 | | | | | | | | |
| Comparative | E | ◯ | 18.4 | Δ | 1.50 | Δ | 37.8 | X |
| Example 3 | | | | | | | | |
| Comparative | F | ◯ | 18.2 | Δ | 2.25 | Δ | 32.3 | X |
| Example 4 | | | | | | | | |
| Comparative | G | ◯ | 19.2 | X | 2.11 | Δ | 42.5 | X |
| Example 5 | | | | | | | | |
| Comparative | H | ◯ | 19.3 | X | 1.80 | Δ | 31.3 | X |
| Example 6 | | | | | | | | |

TABLE 4

| | | Mixing time | Charge quantity Q |
|---|---|---|---|
| | Toner | min | (−μC/g) |
| Example 1 | A | 0 | 24.0 |
| | | 2 | 25.3 |
| | | 4 | 26.5 |
| | | 6 | 24.4 |
| | | 8 | 22.8 |
| | | 10 | 24.4 |
| Example 2 | B | 0 | 20.9 |
| | | 2 | 24.3 |
| | | 4 | 26.3 |
| | | 6 | 23.9 |
| | | 8 | 23.5 |
| | | 10 | 23.1 |
| Comparative | C | 0 | 30.1 |
| Example 1 | | 2 | 26.1 |
| | | 4 | 30.2 |
| | | 6 | 36.2 |
| | | 8 | 32.5 |
| | | 10 | 33.5 |
| Comparative | D | 0 | 24.4 |
| Example 2 | | 2 | 29.4 |
| | | 4 | 33.8 |
| | | 6 | 29.4 |
| | | 8 | 28.5 |
| | | 10 | 25.0 |
| Comparative | E | 0 | 31.6 |
| Example 3 | | 2 | 39.7 |
| | | 4 | 39.1 |
| | | 6 | 40.9 |
| | | 8 | 38.4 |
| | | 10 | 36.9 |
| Comparative | F | 0 | 23.9 |
| Example 4 | | 2 | 35.8 |
| | | 4 | 36.7 |
| | | 6 | 31.1 |
| | | 8 | 33.1 |
| | | 10 | 33.4 |
| Comparative | G | 0 | 35.7 |
| Example 5 | | 2 | 44.1 |
| | | 4 | 43.9 |
| | | 6 | 41.3 |
| | | 8 | 47.1 |
| | | 10 | 42.8 |
| Comparative | H | 0 | 25.2 |
| Example 6 | | 2 | 33.2 |
| | | 4 | 32.5 |
| | | 6 | 32.1 |
| | | 8 | 29.4 |
| | | 10 | 29.4 |

While the invention has been described in detail and with reference to specific embodiments thereof, it will be apparent to one skilled in the art that various changes and modifications can be made therein without departing from the spirit and scope thereof.

The present application is based on Japanese Patent Application No. 2013-267645 filed on Dec. 25, 2013, and the contents are incorporated herein by reference.

1. An electrostatic image developing toner comprising:
toner base particles that contain at least a binder resin, a coloring agent, and a wax; and an external additive, wherein the external additive satisfies the following (A) to (C):
(A) the external additive contains fused silica particles (a),
(B) the external additive contains silica particles (b) different from the silica particles (a) and specific surface area of the silica particles (b) is 50 m²/g or more and 140 m²/g or less, and
(C) the external additive contains particles (c) different from the silica particles (a) and the silica particles (b) and the particles (c) are charged to have a reverse polarity to that of the silica particles (b) and have specific surface area of 5 m²/g or more and 300 m²/g or less.

2. The electrostatic image developing toner according to claim 1, wherein the particles (c) are silica particles treated with an aminosilane coupling agent.

3. A method of producing an electrostatic image developing toner, comprising adding an external additive to toner base particles,
wherein:
the electrostatic image developing toner comprises
toner base particles comprising at least a binder resin, a coloring agent, and a wax, and
the external additive; and
the external additive satisfies the following (A) to (C):
(A) the external additive contains silica particles (a) obtained by a fusion method,
(B) the external additive contains silica particles (b) different from the silica particles (a) and specific surface area of the silica particles (b) is 50 m²/g or more and 140 m²/g or less, and
(C) the external additive contains particles (c) different from the silica particles (a) and the silica particles (b) and the particles (c) are charged to have a reverse polarity to that of the silica particles (b) and have specific surface area of 5 m²/g or more and 300 m²/g or less.

4. The method according to claim 3, wherein the particles (c) are silica particles treated with an aminosilane coupling agent.
